(19) United States
(12) Patent Application Publication
(10) Pub. No.: US 2011/0177899 A1
(43) Pub. Date: Jul. 21, 2011

(54) HYBRID BUSHED-SILENT CHAIN

(75) Inventors: Lucian Botez, Novi, MI (US); Christian Poiret, Coulogne (FR)

(73) Assignee: SCHAEFFLER TECHNOLOGIES GMBH & CO. KG, Herzogenaurach (DE)

(21) Appl. No.: 13/004,391

(22) Filed: Jan. 11, 2011

Related U.S. Application Data
(60) Provisional application No. 61/296,638, filed on Jan. 20, 2010.

(51) Int. Cl. F16G 13/04; B21L 9/06

(52) U.S. Cl. 474/214; 59/7

(57) ABSTRACT

A chain is disclosed having pins, each having a first end and a second end, and first and second outer plates press-fitted around the first and second ends of each of the pins, respectively. Each of the first and second outer plates has two pin holes through which the first and second ends of respective ones of the pins extend, respectively. First and second inner link assemblies, each consisting of at least one toothed inner plate, are disposed between the first and second outer plates. The at least one toothed inner plate has two openings each having a respective bushing press-fitted therein and arranged around respective ones of the pins with a slip-fit. Toothed middle plates, each having two pin holes press-fitted around respective ones of the pins, are disposed between the first and second inner link assemblies.

### CROSS-REFERENCE TO RELATED APPLICATIONS

This application claims the benefit of U.S. Provisional Application No. 61/296,638, filed Jan. 20, 2010, which is incorporated herein by reference as if fully set forth.

### FIELD OF INVENTION

This application is generally related to chains and more particularly related to silent chains used in automotive chain drives.

### BACKGROUND

Chain drives systems are well known in the field of automotives. A typical chain drive uses a chain to transmit power from a driving gear to a driven gear. Silent chains, also known as inverted toothed chains, are generally constructed using only plates and pins. During operation, the links of a silent chain engage with teeth on the driving or driven gear with little impact or sliding, resulting in reduced vibrations and noise in comparison with other chain types. However, known silent chains exhibit a higher wear rate and thus a shorter lifespan than roller or bushed chains. This higher wear rate results from reduced bearing contact surface areas between the plates and pins in silent chains, where only the articulating links contribute to the bearing surface. The effective bearing contact surface area of silent chains is further reduced by stamping breakouts and die-rolls on each plate of the articulating links. In contrast, bushed or roller chains include bushings extending between the outer plates and around the pins that provide a greater bearing contact surface area. Additionally, the bearing contact surface of silent chains is made up of a series of interrupted surfaces, each one corresponding to one plate in an articulating link. This arrangement is prone to small misalignments between consecutive bearing contact surfaces, resulting in non-uniform wear of those surfaces and a higher wear rate overall. Therefore, a need exists for a silent chain with increased resistance against wear and a longer lifespan.

### SUMMARY

A chain is disclosed having pins, each having a first end and a second end, and first and second outer plates press-fitted around the first and second ends of each of the pins, respectively. Each of the first outer plates has two pin holes through which the first end of respective ones of the pins extend, and each of the second outer plates has two pin holes through which the second end of respective ones of the pins extend. First and second inner link assemblies are disposed between the first and second outer plates. Each of the first and second inner link assemblies consists of at least one toothed inner plate, which has two openings, each having a respective bushing press-fitted therein. The bushings are arranged around respective ones of the pins with a slip-fit. Toothed middle plates are disposed between the first and second inner link assemblies. Each of the toothed middle plates has two pin holes press-fitted around respective ones of the pins. The first and second outer plates and the toothed middle plates are aligned with each other, and the first and second inner link assemblies are aligned with each other and offset by one pin from the toothed middle plates.

In other embodiments of the chain, each of the first and second inner link assemblies consists of at least two toothed inner plates, each having two openings and arranged such that the two openings of one of the at least two toothed inner plates are aligned with the two openings of the other of the at least two toothed inner plates. The respective bushings are press-fitted through the respective pairs of aligned openings of the at least two toothed inner plates, joining the at least two toothed inner plates together. The at least two toothed inner plates may be arranged so there is substantially no distance between the two, or the at least two toothed inner plates may contact each other. Additionally, the bushings may be completely pressed into the at least one toothed inner plate and arranged such that a first end and a second end of each of the bushings is flush with a top surface and a bottom surface of the at least one toothed inner plate, respectively. For two or more toothed inner plates, the bushings are preferably flush to the outer side surfaces of the aligned plates. For sake of brevity, this summary does not list all aspects of the present chain, which is described in further detail below.

### BRIEF DESCRIPTION OF THE DRAWINGS

The foregoing summary, as well as the following detailed description of the preferred embodiments of the invention will be better understood when read in conjunction with the appended drawings. For the purpose of illustrating the invention, there is shown in the drawings embodiments which are presently preferred. It should be understood, however, that the invention is not limited to the precise arrangement shown.

FIG. 1 is a top elevational view of a prior art silent chain.

FIG. 2 is a cross-sectional view of the prior art silent chain shown in FIG. 1.

FIG. 3 is a fragmentary cross-sectional view of the prior art silent chain shown in FIG. 1.

FIG. 4 is a cross-sectional view of a prior art bushed chain.

FIG. 5 is a top elevational view of an embodiment of the chain of the current invention.

FIG. 6 is a cross-sectional view of the chain shown in FIG. 5.

FIG. 7 is a fragmentary cross-sectional view of the chain shown in FIG. 5.

FIG. 8 is a cross-sectional view of another embodiment of the chain of the current invention.

FIG. 9 is a fragmentary cross-sectional view of the chain shown in FIG. 8.

### DETAILED DESCRIPTION OF THE PREFERRED EMBODIMENTS

Certain terminology is used in the following description for convenience only and is not limiting. The words “inner,” “outer,” “top,” and “bottom” designate directions in the drawings to which reference is made. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

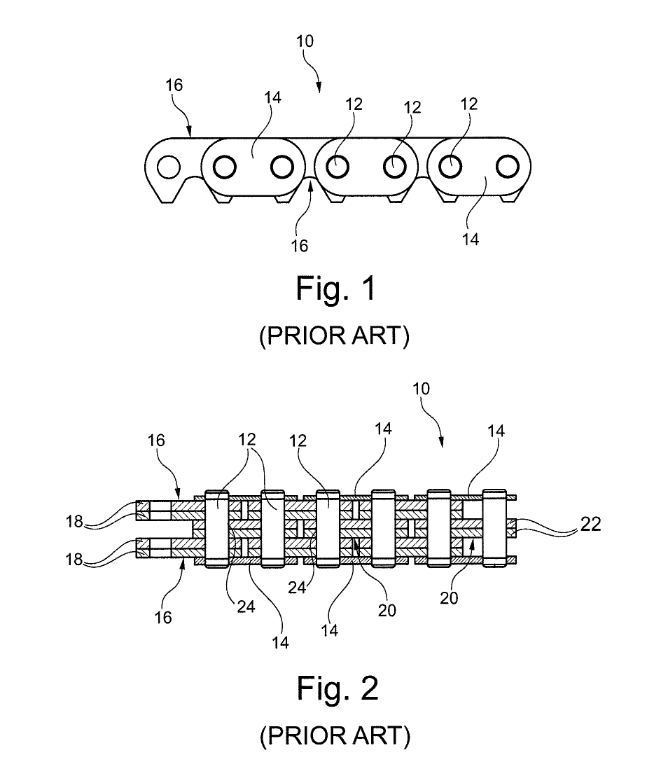

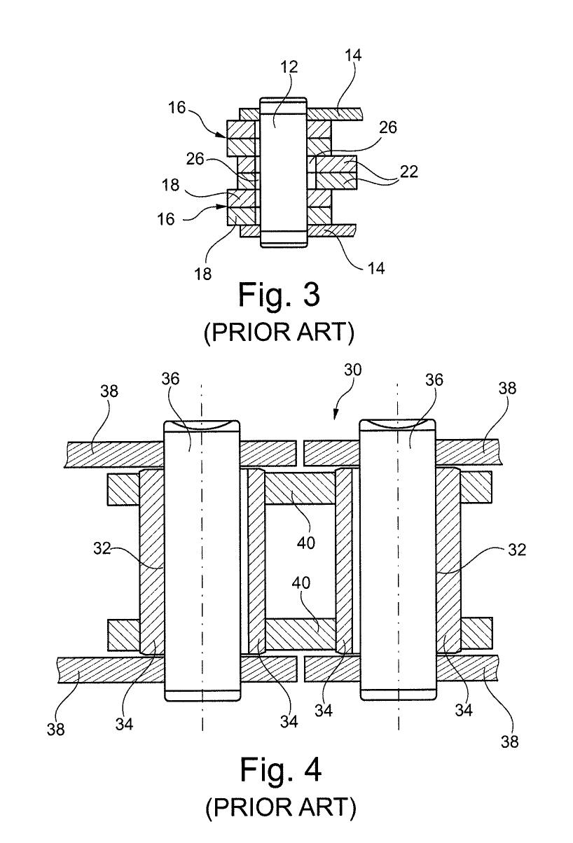

FIGS. 1-3 show a prior art silent chain having pins 12 joined by outer plates 14, inner links 16, and middle links 20. The outer plates 14 are press-fitted onto the pins. Each of the inner links 16 is made up of inner plates 18, and each of the middle links 20 is made up of middle plates 22. The inner plates 18 and middle plates 22 are arranged about the pins 12 with a clearance-fit. As shown in FIGS. 2 and 3, because of the multiple inner plates 18 and middle plates 22 included in the inner links 16 and middle links 20, the bearing contact surface 24 between the pins 12 and the inner and middle links 16, 20 is interrupted, resulting in multiple edge loading and contact pressure peaks. This undesired increase in local contact pressure results in a higher joint wear rate. Pin bending also increases edge loading and contributes to the higher joint wear. The degree of pin bending is generally proportional to the clearance 26 between the middle plates 22 and the pins 12.

FIG. 4 shows a prior art bushed chain 30 having pins 36 joined by outer plates 38 and inner plates 40, and continuous bearing surfaces 32 between a bushing 34 and each pin 36. Although the continuous bearing surfaces 32 reduce the joint wear rate, the prior art bushed chain 30 is prone to pin bending, which increases with the length of the pin 36 and results in high contract pressure distribution at two local edge loading points at both ends of each bushing 34.

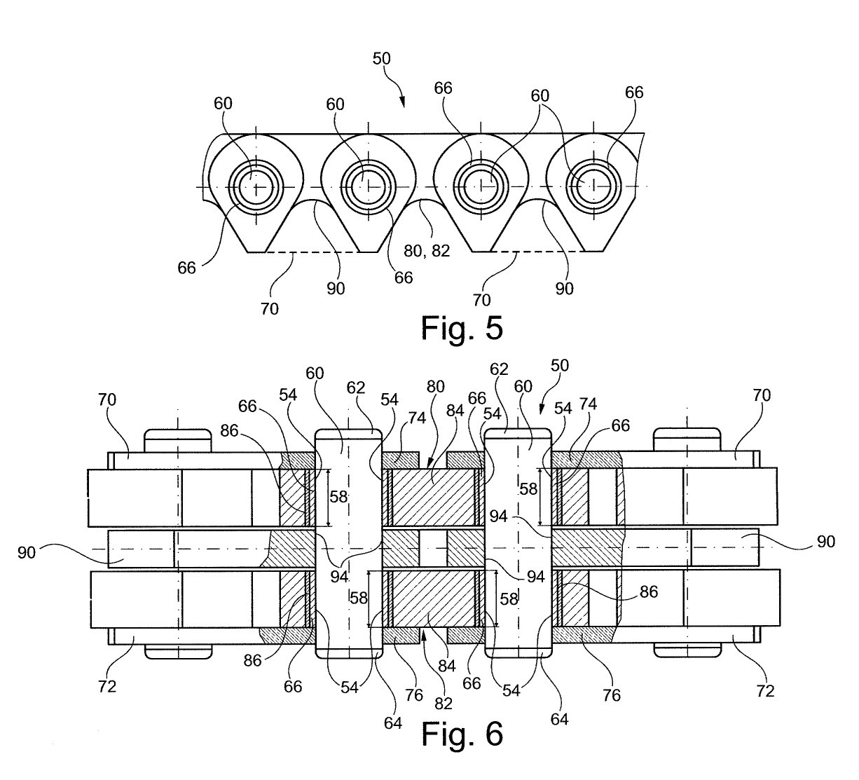

FIGS. 5-7 show one embodiment of the chain 50 according to the present invention. The chain 50 includes pins 60, each having a first end 62 and a second end 64, and first and second outer plates 70, 72 press-fitted around the first and second ends 62, 64 of each of the pins 60, respectively. Each of the first outer plates 70 has two pin holes 74 through which the first end 62s of respective ones of the pins 60 extend, and each of the second outer plates 72 has two pin holes 76 through which the second ends 64 of respective ones of the pins 60 extend. First and second inner link assemblies 80, 82 are disposed between the first and second outer plates 70, 72. Each of the first and second inner link assemblies 80,82 consists of at least one toothed inner plate 84, which has two openings 86 each having a respective bushing 66 press-fitted therein. The bushings 66 are arranged around respective ones of the pins 60 with a slip-fit. Toothed middle plates 90 are disposed between the first and second inner link assemblies 80, 82. Each of the toothed middle plates 90 has two pin holes 94 press-fitted around respective ones of the pins 60. The slip-fit between the bushings 66 and the pins 60 allows for relative motion between the first and second outer plates 70, 72 and the first and second inner link assemblies 80, 82. As shown in FIG. 6, the first and second outer plates 70, 72 and the toothed middle plates 90 are aligned with each other, and the first and second inner link assemblies 80, 82 are aligned with each other and offset by one pin 60 from the toothed middle plates 90. The first and second outer plates 70, 72, toothed inner plates 84, and toothed middle plates 90 may be made from any suitable material, such as steel, and produced by fine-blanking, stamping, or stamping and shaving, depending on the manufacturing limitations and cost effectiveness.

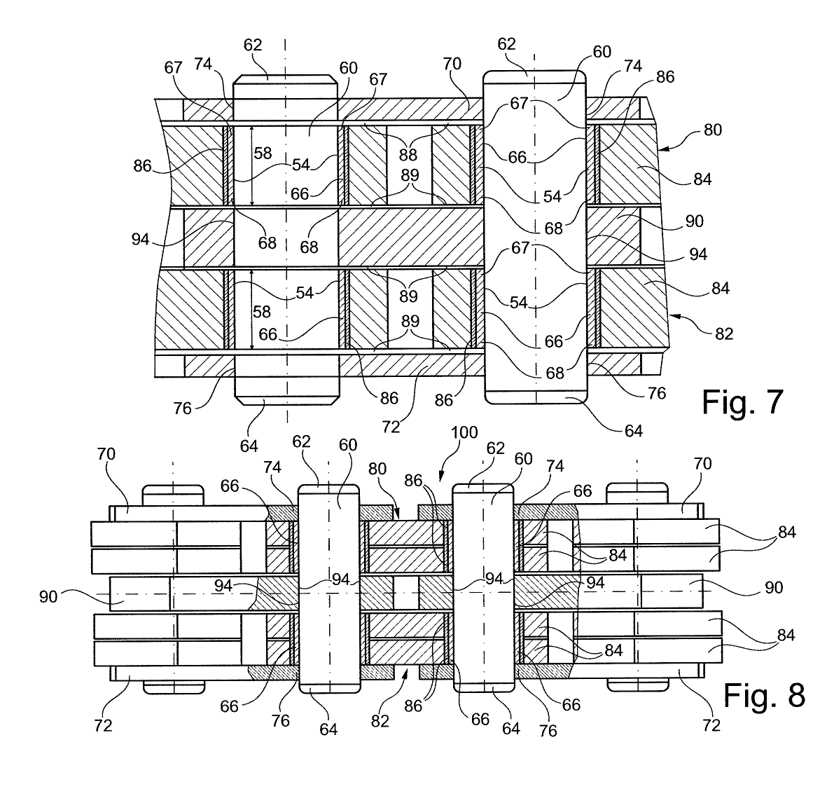

As shown in FIGS. 6-7, two continuous bearing contact surfaces 54 are formed between the bushings 66 and pins 60 on each side of the toothed middle plates 90. Because the first and second outer plates 70, 72 and the toothed middle plates 90 are pressed-fitted onto the pins 60, two short stiff pin segments 58 are created. When a chain axial force is applied during operation, only a small amount of pin bending is generated because of the short stiff pin segments 58. This in turn results in reduced edge loading of the continuous bearing contact surfaces 54.

In addition to providing the continuous bearing contact surfaces 54, the bushings 66 also provide a better interface between the pins 60 and the first and second inner link assemblies 80, 82. The toothed inner plates 84 of the first and second inner link assemblies 80, 82 are usually formed from steel with a medium carbon level (e.g., SAE 1055 or DIN C55 steel), which is hardened and tempered to approximately 50 HRC. The hardness of the toothed inner plates 84 is generally insufficient for a chain running in highly contaminated oil, such as in a Diesel engine that contains soot from combustion, and therefore prior art silent chains experience rapid wear of the toothed inner plates' inner bore surfaces. By utilizing bushings 66 formed from materials with a greater hardness, the present chain offers higher surface hardness and improved wear of the continuous bearing contact surfaces 54. The inner surfaces of the bushings 66 are also straighter and have better finishes than prior art toothed inner plates' inner bore surfaces, which are usually formed through stamping, shaving, or fine-blanking cutting. The bushings 66 may be made from any material having the desired hardness, preferably a case hardening steel such as SAE 1010, SAE 1012, SAE 8620, DIN 16MnCr5, DIN C10, or DIN C20, and may be formed by curling, deep-drawing, extrusion, or any other suitable method. The bushings 66 may be subjected to typical heat treatments for roller or bushed chains. For example, carburizing the bushings 66 typically results in surface hardness of greater than 650 HV and a case depth with a martensitic structure. Carbonitriding or nitrocarburizing the bushings 66 results in even higher surface hardness. Carbonitriding the bushings 66 creates a diffusion layer of approximately 40 microns deep (measured from the surface of the bushing 66) that is rich in carbides and nitrides and provides good wear resistance. The nitrocarburizing process also creates a thin “white layer” of approximately 14 microns deep that is rich in nitrogen, has a high hardness, and provides good wear resistance. In contrast, prior art silent chains' plate bearing surfaces are usually limited to heat treatments that produce a hardened or slightly carburized surface.

As shown in FIG. 7, each of the bushings 66 is preferably completely pressed into the at least one toothed inner plate 84 and arranged such that a first end 67 and a second end 68 of each of the bushings 66 is flush with a top surface 88 and a bottom surface 89 of the at least one toothed inner plate 84, respectively. It should be understood that due to manufacturing tolerances, a small protrusion of the first and second ends 67, 68 of each of the bushings 66 with respect to the top and bottom surfaces 88, 89 of the at least one toothed inner plate 84 may exist. Because the bushings 66 are completely pressed into and thus firmly supported by the at least one toothed inner plate 84, the wall thickness of each of the bushings 66 can be decreased compared to a prior art roller or bushed chain with a similar pitch. Decreasing the wall thickness allows the inner diameter of the bushings 66 and diameters of the pins 60 to be maximized, which offsets the shorter axial length of the bushings 66 and provides a larger continuous bearing contact surface comparable to the bearing contact surface area of a corresponding traditional bushed chain. For example, a normal bushing for a 8 mm prior art roller chain usually has an outer diameter of 4.32 mm and wall thickness of 0.6 mm, and a normal bushing for a 8 mm prior art bushed chain usually has an outer diameter of 5 mm and wall thickness of 0.8 mm. In contrast, each of the bushings 66 of the chain 10 may have a wall thickness as low as 0.3 mm for the same outer diameters. An optimum value for the wall thickness of the bushings 66 may be determined depending on the chain pitch.

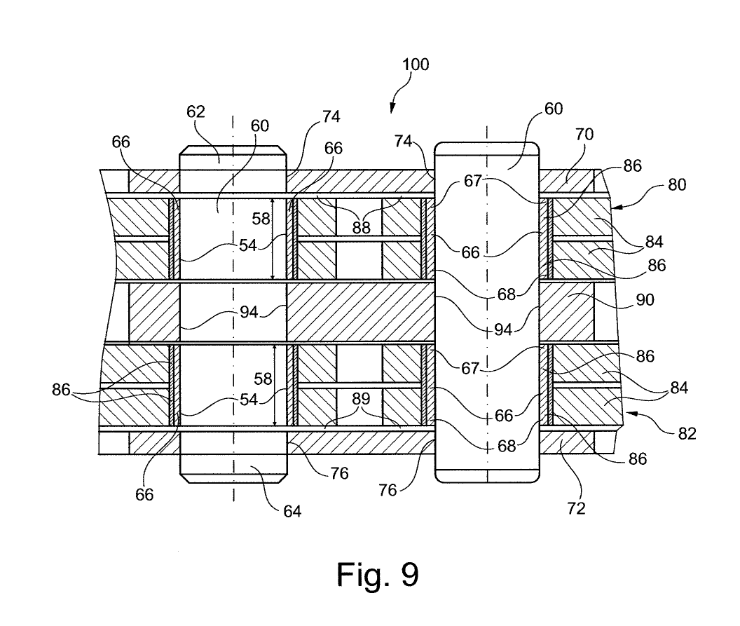

In an alternate embodiment of the present chain 100, as shown in FIGS. 8-9, the chain 100 includes the pins 60 with first and second outer plates 70, 72 press-fitted around the first and second ends 62, 64 of each of the pins 60, respectively, and the first and second inner link assemblies 80, 82 disposed between the first and second outer plates 70, 72. In this alternate embodiment, each of the first and second inner link assemblies 80, 82 consists of at least two toothed inner plates 84, each of which has two openings 86. The at least two toothed inner plates 84 are arranged such that the two openings 86 of one of the at least two toothed inner plates 84 are aligned with the two openings 86 of the other of the at least two toothed inner plates 84, and the respective bushings 66 are press-fitted through the respective pairs of aligned openings 86 of the at least two toothed inner plates 84, joining the at least two toothed inner plates 84 together. The bushings 66 are arranged around respective ones of the pins 60 with a slip-fit. The chain 100 also includes toothed middle plates 90 disposed between the first and second inner link assemblies 80, 82, each of the toothed middle plates 90 having two pin holes 94 press-fitted around respective ones of the pins 60. The first and second outer plates 70, 72 and the toothed middle plates 90 are aligned with each other, while the first and second inner link assemblies 80, 82 are aligned with each other and offset by one pin from the toothed middle plates 90. The first and second outer plates 70, 72, at least two toothed inner plates 84 of the first and second inner link assemblies 80, 82, the toothed middle plates 90, and the bushings 66 may be made from the same materials and the same processes as described above with respect to FIGS. 5-7.

As shown in FIG. 9, each of the bushings 66 is preferably completely pressed into the at least two toothed inner plates 84 of each of the first and second inner link assemblies 80, 82 and arranged such that a first end 67 of each of the bushings 66 is flush with a top surface 88 of one of the at least two toothed inner plates 84 and a second end 68 of each of the bushings 66 is flush with a bottom surface 89 of the other of the at least two toothed inner plates 84. As described above with respect to FIGS. 5-7, press-fitting the bushings 66 completely into the at least two toothed inner plates 84 allows the bushings 66 to be firmly supported by the at least two toothed inner plates. Consequently, the wall thickness of each of the bushings 66 may be decreased while the inner diameter of each of the bushings 66 is increased to maximize the diameter of the pins 60 and the continuous bearing contact surfaces 54 between the bushings 66 and the pins 60. Due to manufacturing tolerances, a small protrusion of the first and second ends 67, 68 of each of the bushings 66 may exist with respect to the top surface 88 of one of the at least two toothed inner plates 84 and the bottom surface 89 of the other one of the at least two toothed inner plates 84, respectively.

As shown in FIGS. 8-9, the at least two toothed inner plates 84 of the first and second inner link assemblies 80, 82 may be arranged with a small space between each other. This minimal spacing is only due to manufacturing tolerances, generally approximately 0.25 mm, and can be considered to be substantially no distance between the at least two toothed inner plates 84. Alternatively, the at least two toothed inner plates 84 may contact each other. Arranging the at least two toothed inner plates 84 in the above manner ensures maximum support for the bushings 66, which as discussed above have a reduced wall thickness since they are press-fitted completely into the openings 86 of the at least two toothed inner plates 84.

In another alternate embodiment of the chain, which is not illustrated in the drawings, the toothed middle plates may each include first and second middle plates disposed between the first and second inner link assemblies 80, 82. The first and second middle plates each include two aligned pin holes 94 press-fitted around respective ones of the pins 60. The first and second middle plates may be arranged with substantially no distance between each other, meaning the only spacing is due to manufacturing tolerances. Alternatively, the first and second middle plates may contact each other.

In yet another alternate embodiment of the chain, also not illustrated in the drawings, the first and second middle plates are spaced apart from each other, with third inner link assemblies disposed between the first and second middle plates. Each of the third inner link assemblies consists of at least one toothed inner plate 84, which has two openings 86 each having a respective bushing 66 press-fitted therein. The bushings 66 are arranged around respective ones of the pins 60 with a slip-fit. The chain according to the present invention may be further modified by increasing the sets of toothed inner plates 84 in each of the first, second, or third inner link assemblies, by increasing the sets of first and second outer plates 70, 72, by increasing the sets of toothed middle plates 90, or by placing additional inner link assemblies between any two consecutive toothed middle plates 90.

A method for assembling a chain is also disclosed, including the following steps. Pins 60, each having a first end 62 and a second end 64, are provided. First outer plates 70 are press-fitted around the first end 62 of each of the pins 60, each of the first outer plates 70 having two pin holes 74 through which the first end 62 of respective ones of the pins 60 extend. First inner link assemblies 80 are slip-fitted around each of the pins 60. Each of the first inner link assemblies 80 consists of at least one toothed inner plate 84, which has two openings 86 each having a respective bushing 66 press-fitted therein. The bushings 66 are arranged around respective ones of the pins 60 with a slip-fit. Toothed middle plates 90, each having two pin holes 94, are press-fitted around each of the pins 60 such that the first inner link assemblies 80 are sandwiched between the first outer plates 70 and the toothed middle plates 90. Second inner link assemblies 82 are slip-fitted around each of the pins 60. Like the first inner link assemblies 80, each of the second inner link assemblies 82 consists of at least one toothed inner plate 84, which has two openings 86, each having a respective bushing 66 press-fitted therein. The bushings 66 are arranged around respective ones of the pins 60 with a slip-fit. Second outer plates 72 are press-fitted around the second end 64 of each of the pins 60. Each of the second outer plates 72 has two pin holes 76 through which the second end 64 of respective ones of the pins 60 extend.

Having thus described various embodiments of the present chain in detail, it is to be appreciated and will be apparent to those skilled in the art that many physical changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A chain comprising:
pins, each having a first end and a second end;
first and second outer plates press-fitted around the first and second ends of each of the pins, respectively, each of the first outer plates having two pin holes through which the first end of respective ones of the pins extend, and each of the second outer plates having two pin holes through which the second end of respective ones of the pins extend;
first and second inner link assemblies disposed between the first and second outer plates, each of the first and second inner link assemblies consisting of at least one toothed inner plate, the at least one toothed inner plate having two openings each having a respective bushing press-fitted therein, and the bushings are arranged around respective ones of the pins with a slip-fit;
toothed middle plates disposed between the first and second inner link assemblies, each of the toothed middle plates having two pin holes press-fitted around respective ones of the pins; and
the first and second outer plates and the toothed middle plates are aligned with each other, and the first and second inner link assemblies are aligned with each other and offset by one pin from the toothed middle plates.

2. The chain of claim 1, wherein each of the bushings is completely pressed into the openings of the at least one toothed inner plate and arranged such that a first end and a second end of each of the bushings is flush with a top surface and a bottom surface of the at least one toothed inner plate, respectively.

3. The chain of claim 2, wherein each of the bushings has a wall thickness of less than 0.8 mm.

4. The chain of claim 3, wherein each of the bushings has a wall thickness of 0.3 mm.

5. The chain of claim 1, wherein the at least one toothed inner plate consists of at least two toothed inner plates, each of the at least two toothed inner plates having two openings and the at least two toothed inner plates are arranged such that the two openings of one of the at least two toothed inner plates are aligned with the two openings of the other of the at least two toothed inner plates, and the respective bushings are press-fitted in the aligned openings of the at least two toothed inner plates, joining the at least two toothed inner plates together.

6. The chain of claim 5, wherein each of the bushings is completely pressed into the aligned openings of the at least two toothed inner plates and arranged such that a first end and a second end of each of the bushings is flush with a top surface of one of the at least two toothed inner plates and a bottom surface of the other of the at least two toothed inner plates, respectively.

7. The chain of claim 6, wherein there is substantially no distance between the at least two toothed inner plates.

8. The chain of claim 7, wherein the at least two toothed inner plates contact each other.

9. A method for assembling a chain, the method comprising:
providing pins, each having a first end and a second end;
press-fitting first outer plates around the first end of each of the pins, each of the first outer plates having two pin holes through which the first end of respective ones of the pins extend;
slip-fitting first inner link assemblies around each of the pins, each of the first inner link assemblies consisting of at least one toothed inner plate, the at least one toothed inner plate having two openings each having a respective bushing press-fitted therein, and the bushings are arranged around respective ones of the pins with a slip-fit;
press-fitting toothed middle plates, each having two pin holes, around each of the pins such that the first inner link assemblies are sandwiched between the first outer plates and the toothed middle plates;
slip-fitting second inner link assemblies around each of the pins, each of the second inner link assemblies consisting of at least one toothed inner plate, the at least one toothed inner plate having two openings each having a respective bushing press-fitted therein, and the bushings are arranged around respective ones of the pins with a slip-fit; and
press-fitting second outer plates around the second end of each of the pins, each of the second outer plates having two pin holes through which the second end of respective ones of the pins extend.
